(19) United States
(12) Patent Application Publication
(10) Pub. No.: US 2016/0032223 A1
(43) Pub. Date: Feb. 4, 2016

(54) CLEANING COMPOUND

(71) Applicant: T. Jack Wert, Sheffield Village, OH (US)

(72) Inventor: T. Jack Wert, Sheffield Village, OH (US)

(21) Appl. No.: 14/813,725

(22) Filed: Jul. 30, 2015

Related U.S. Application Data
(60) Provisional application No. 62/030,829, filed on Jul. 30, 2014.

(51) Int. Cl. C11D 3/37; C11D 1/12; C11D 3/48

(52) U.S. Cl. CPC C11D 3/3757; C11D 3/48; C11D 1/12

(57) ABSTRACT

A polymer compound for cleaning has a first part and a second part. The compound activates to form a dispersion matrix that traps at least one of a particulate and fluid from a surface. The compound can have a polymerizing agent, an antimicrobial agent, a viscosity controller, a drying agent, a polymerization catalyst, and a surfactant.

### CLAIM OF PRIORITY

This application claims priority from Provisional Patent Application Ser. No. 62/030,829, filed on Jul. 30, 2014, the entirety of which is hereby incorporated by reference.

### BACKGROUND OF THE DISCLOSURE

The present disclosure relates to surface cleaning agents. More specifically, it relates to a polymer compound for removing dirt from surfaces such as the dermal layer of a user's hand without the need to use an additional solvent or a carrying agent such as water.

Hard surfaces occurring in the home and in the institutional sector are cleaned with various cleaners which differ from one another both in the concentration of their cleaning-active ingredients, in the form in which they are packaged, for example concentrates, spray cleaners, gels and powders, and in their pH value, for example acidic, neutral and alkaline cleaners. The cleaners are essentially aqueous solutions of surfactants which may contain additional elements or compounds such as builders, water-soluble solvents, solubilizers, water-soluble abrasives, etc. as additives. To be able to meet consumer requirements, cleaners of the type in question are required to be effective against all the various soils to be cleaned or removed.

The cleaners are primarily in the form of amphiphilic surfactants designed to be dispersed in a fluid carrier and capable of bonding to both polar and nonpolar molecules in such a way that abundant chemicals like water (Polar) can disperse the oils (Nonpolar) which tend trap organic and inorganic micro debris and adhere them to environmental surfaces. Included in these micro debris are pathogens and spoors known to cause disease and surface degradation. These surfactants come in many forms but are typically the salt of a fatty acid (e.g., soaps) or ethoxylates such as sodium laureth sulfate.

European Patent Application EP-A 0 467 472 describes an existing cleaner for hard surfaces which contains water-soluble anionic, cationic or nonionic polymers as soil release compounds. Polymers containing quaternized ammonium alkyl methacrylate groups in the molecule are mentioned in particular as examples of such polymers. The cleaners described in this document only develop their soil-repelling effect after having already been applied once to the hard surface.

Published PCT Application No. WO 2011/004399 refers to a liquid filmogenic wound cleaner which is made of pharmaceutical grade chitosan. While this cleaner uses a polyglucosamine compound, it is not directed to a compound which changes from liquid to solid to absorb dirt from a surface.

PCT Published Application No. WO 2012/032493 relates to a polyvinyl skin cleaner containing a high concentration of retinoric acid. While this cleaner used a PVA polymer base, it is not directed to a compound which changes from liquid to solid to absorb dirt from a surface.

Referring to U.S. Pat. No. 5,364,904, it is well established that certain chemicals will undergo a non reversible polymerization reaction that these higher molecular weight reactants have a significantly greater viscosity. It is also well established in the art that some reactions may be catalyzed or inhibited by the addition of other secondary chemicals which are incidental to the desired application of the product but nevertheless are necessary to form the product.

Thus, it would be desirable to provide cleaners which do not require additional dispersants such as water, and cleaning compounds that would act as the release agent, dispersant, and as a collector, and that overcome the above-mentioned difficulties and others while providing an improved and better overall result.

### SUMMARY OF THE DISCLOSURE

In accordance with one embodiment of the present disclosure, a cleaning substance is provided which would act as the release agent, dispersant and as a collector.

Another embodiment of the disclosure is that the cleaning compound change phase from liquid to solid or significantly change viscosity to trap particulates in the dispersion matrix for optimal performance.

Another embodiment of the disclosure is surfactant solutions for the manual cleaning of hard surfaces, which would positively influence or at least would not reduce the removal of soil and dispersion of the soil removed in the cleaning liquor during the first application.

Still another embodiment of the disclosure is a polymer compound capable of dispersing debris and fluids regardless of surface chemistry into its volume and trapping them.

Another embodiment of the disclosure is the compound which is hydrophilic and water absorbent.

Another embodiment of the disclosure is which changes phase from a liquid to a solid.

Another embodiment of the disclosure is a gel or thick liquid that becomes more viscous after activation.

Another embodiment of the disclosure is a compound comprised of two parts, one which is hydrophilic and another which is lipophilic.

Another embodiment of the disclosure is a compound which is antimicrobial or includes an antimicrobial agent.

Another embodiment of the disclosure is a compound which contains a blowing agent that causes expansion when activated.

Another embodiment of the disclosure is a compound which is a binary compound that activates when both parts are mixed together.

Another embodiment of the disclosure is a compound which has a polymerization inhibitor that evaporates to activate the compound.

Another embodiment of the disclosure is a binary compound where one part is suspended in the other as micro “droplets” or “beads” and activates when sufficient agitation is applied to breakdown the micro beads.

Another embodiment of the disclosure is a compound contains a dye in either part to optically distinguish them.

Another embodiment of the disclosure is a compound which is comprised of Poly (Vinyl acetate) as an Aqueous latex.

Another embodiment of the disclosure is a compound which contains Amphoteric Salts acting as buffer agents.

Another embodiment of the disclosure is a compound which contains a Carboxylic acid or its salt as a transesterification crosslinking agent.

Another embodiment of the disclosure is a compound which contains a fragrance.

Another embodiment of the disclosure is a Polyvinyl acetate emulsion containing phenolic or aliphatic functional groups suitable for crosslinking.

Another embodiment of the disclosure is a unique aerobic cross-linking catalyst system for use with a polymeric cleaning compound.

Another embodiment of the disclosure is a an improved wood glue system comprising a polyvinyl acetate copolymer emulsion additives and a unique cross-linking catalyst which can be added to the emulsion to provide cleaning compound with desired properties.

In accordance with another embodiment of the disclosure, a polymer compound for cleaning has a first part and a second part, wherein the compound activates to form a dispersion matrix that traps at least one of a particulate and fluid from a surface.

In accordance with another embodiment of the disclosure, a polymer compound for cleaning a surface has a polymerizing agent, an antimicrobial agent, a viscosity controller, a drying agent, a polymerization catalyst, and a surfactant.

In accordance with another embodiment of the disclosure, a product contains a cleaning compound as described above, wherein the product has at least one of a release agent, a dispersant, and a collector of particulates and fluids.

Still other embodiments of the disclosure will become apparent upon a reading and understanding of the following detailed description.

### BRIEF DESCRIPTION OF THE DRAWINGS

FIG. 1 is a graph illustrating the physical phase plotted across time as the solvent evaporates and the compound incorporates into a foreign particulate.

FIG. 2 is a graph illustrating the mechanism of action of Formula 4.

FIG. 3 is a table illustrating three exemplary embodiments of a cleaning compound according to the present disclosure.

### DETAILED DESCRIPTION OF THE DISCLOSURE

A more complete understanding of the compounds, parts, components, and processes disclosed herein can be obtained by reference to the following detailed description of desired embodiments and the examples included therein.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named components/steps and permit the presence of other components/steps. However, such description should be construed as also describing compositions or processes as “consisting of” and “consisting essentially of” the enumerated components/steps, which allows the presence of only the named components/steps, along with any impurities that might result therefrom, and excludes other components/steps.

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2% to 10%” is inclusive of the endpoints, 2% and 10%, and all the intermediate values).

The term “about” can be used to include any numerical value that can vary without changing the basic function of that value. When used with a range, “about” also discloses the range defined by the absolute values of the two endpoints, e.g. “about 2 to about 4” also discloses the range “from 2 to 4.” The term “about” may refer to plus or minus 10% of the indicated number.

As used herein, the term “micro” refers to objects smaller than the volume of the cleaning compound in question.

As used herein, the term “macro” refers to objects larger than the volume of the cleaning compound in question.

This disclosure is related to a surface cleaning agent and specifically, it is directed to a polymer compound that changes phase from a liquid to a solid by some mixing or dispersing action and is formulated so that any type of micro debris or fluid will mix with the compound when in the liquid phase and become trapped after the transition to a soft solid or viscous gel. Furthermore, it will not readily adhere to other macro objects after such a phase transition has occurred. Several embodiments of the disclosure are summarized below.

The present disclosure relates to cleaning compounds that contain at least six components, including a polymerizing agent, an antimicrobial agent, an adhesion controller, a reaction inhibitor, a viscosity controller, a drying agent, a polymerization catalyst, a surfactant, and a plasticizer. In particular embodiments, the cleaning compounds of the present disclosure may contain one or more of each component. For example, in particular embodiments, the compound may contain one or more polymerizing agents, or one or more viscosity controllers. Each of these components may be present in an amount of from about 0 wt % to about 99 wt %.

The polymerizing agent may be present in an amount of from about 0.1 wt % to about 99 wt %. In more specific embodiments, the polymerizing agent is present in amounts of about 20 wt % to about 90 wt %, or about 26 wt % to about 56 wt %, or about 28 wt % to about 56 wt %, or about 80 wt % to about 86 wt %.

The antimicrobial agent may be present in an amount of from about 0 wt % to about 30 wt %. In more specific embodiments, the antimicrobial agent is present in amounts of about 0 wt % to about 25 wt %, or about 5 wt % to about 23 wt %, or about 19 wt % to about 23 wt %.

The adhesion controller may be present in an amount of from about 0 wt % to about 10 wt %. In more specific embodiments, the adhesion controller is present in amounts of about 0 wt % to about 5 wt %, or about 0 wt % to about 2 wt %, or about 0.1 wt % to about 1 wt %.

The reaction inhibitor may be present in an amount of from about 0 wt % to about 10 wt %. In more specific embodiments, the reaction inhibitor is present in amounts of about 0 wt % to about 5 wt %, or about 0 wt % to about 2 wt %, or about 0.1 wt % to about 1 wt %.

The viscosity controller may be present in an amount of from about 0 wt % to about 30 wt %. In more specific embodiments, the viscosity controller may be present in amounts of about 0 wt % to about 25 wt %, or about 1 wt % to about 22 wt %, or about 4.5 wt % to about 22 wt %, or about 0.1 wt % to about 5 wt %.

The drying agent may be present in an amount of from about 0 wt % and 30 wt %. In more specific embodiments, the drying agent may be present in amounts of about 5 wt % to about 26 wt %, or about 7 wt % to about 22 wt %.

The polymerization catalyst may be present in an amount of from about 0 wt % to about 10 wt %. In more specific embodiments, the polymerization catalyst may be present in amounts of about 0.1 wt % to about 5 wt %, or about 0.5 wt % to about 1.5 wt %.

The surfactant may be present in an amount of from about 0 wt % to about 10 wt %. In more specific embodiments, the surfactant may be present in amounts of about 1 wt % to about 3 wt %, or about 1.5 wt % to about 3 wt %, or about 0.1 wt % to about 1 wt %.

According to various aspects of the present disclosure, each component may serve one or more purposes or functions.

In particular embodiments, the antimicrobial agent is also at least one of a preservative and a solvent. In some embodiments, the antimicrobial agent may be ethanol, ethanol (SD 40), or isopropyl alcohol.

In particular embodiments, the adhesion controller is also a viscosity controller and assists in the removal of solids from surfaces. In some embodiments, the adhesion controller may be dimethicone.

In particular embodiments, the reaction inhibitor is also at least one of a stabilizer, a blowing agent, and a propellant. In more specific embodiments, the reaction inhibitor is also a blowing agent that causes the compound to expand when the compound is activated. In some embodiments, the reaction inhibitor may be at least one of tartaric acid and carbon dioxide.

In particular embodiments, the viscosity controller is also at least one of a binder, a nonionic solvent, and a humectant. In some embodiments, the viscosity controller may be at least one of a vegetable oil (e.g., olea europaea) and a volatile oil, such as lemon (limonene) or cymbopogon (lemongrass).

In particular embodiments, the drying agent is also at least one of a pH adjustor, an abrasive, and a solvent. In some embodiments, the drying agent may be at least one of sodium bicarbonate and acetone.

In some embodiments, the polymerizing agent may be a hydrous oligomer emulsion. In more specific embodiments, the polymerizing agent may be at least one of a polyvinyl acetate polymer, a polyvinyl acetate copolymer, and casein. In some embodiments, the polymerizing agent may be polyvinyl acetate polymers or copolymers that have been modified with aliphatic resins. In particular embodiments, the polymerizing agent may contain phenolic or aliphatic functional groups suitable for crosslinking.

In some embodiments, the polymerization catalyst may also be at least one of an amphoteric buffer agent and a saponifier. In some embodiments, the polymerization catalyst may be at least one of sodium tetraborate pentahydrate, acetic acid, boric acid, and sodium bicarbonate.

In some embodiments, the surfactant may be at least sodium laureth sulfate.

In some embodiments, the compound further includes a plasticizer. In particular embodiments, the plasticizer may be glycerol.

Other embodiments or combinations of elements are also contemplated by the disclosure. For example, other alcohols such as benzyl alcohol or isopropyl alcohol, and hydroxbenzoales or phenols may be used as part of the component.

In particular embodiments, the cleaning compounds of the present disclosure comprise at least two parts, wherein each part includes at least two of the components described above. In more specific embodiments, the cleaning compounds are binary compounds consisting of two parts, wherein each part consists of between two and four of the components described above.

In some embodiments, the compound may be a binary compound comprising a first part and a second part. In particular embodiments, the first part of a binary compound may include a polymerizing agent and an antimicrobial agent. In other embodiments, the first part of a binary compound may include a polymerizing agent, an antimicrobial agent, an adhesion controller, and a reaction inhibitor.

In particular embodiments, the second part of a binary compound according to the present disclosure may include a viscosity controller, a drying agent, a polymerization catalyst, a surfactant, and a plasticizer.

In some embodiments, at least one of the parts of the cleaning compounds described herein may further comprise at least one of a buffer agent and a crosslinking agent.

In some embodiments, the buffer agent may be an amphoteric salt.

In some embodiments, the crosslinking agent may be a transesterification crosslinking agent. In particular embodiments, the crosslinking agent may be carboxylic acid or a salt made from carboxylic acid.

Importantly, the components of the cleaning compounds disclosed herein activate in order to form a dispersion matrix that traps the particulates and fluids sitting on a surface.

In particular embodiments, the compound is activated at least when the first part and the second part are combined. In other embodiments, the compound may be activated when the compound is agitated. For example, if particular embodiments, at least one part and/or component of the compound may be suspended in at least one other part and/or component of the compound as microbeads or micro-droplets. As a result of agitation, the microbeads may be broken-down, thus initiating the activation of the compound. In still further embodiments, the compound may be activated at least when the reaction inhibitor evaporates away from the compound.

After the compound is activated, the polymerizing agent undergoes polymerization, forming a dispersion matrix that traps any particulates or fluids in contact with the compound. In particular embodiments, the compound becomes more viscous after the compound is activated. In some embodiments, the compound changes phase from a liquid to at least one of a solid, soft solid, and viscous gel after the compound is activated.

Importantly, after the compound is activated and has trapped any particulates, debris, or fluids in which it mixed with or came into contact with, the adhesiveness of the compound decreases. As a result, the activated compound no longer readily adheres to macro objects, such as the surface is was applied to, and may easily be cleared.

In particular embodiments, the compound may further comprise at least one additive. For example, in some embodiments, at least one dye may be added to one of the parts of a binary compound in order to be able to easily distinguish between the two parts. In other embodiments, at least one fragrance may be added to the compound or a part of the compound.

In particular embodiments, the cleaning compounds disclosed herein may be used to remove particulates, debris, or fluids from a surface regardless of surface chemistry by forming a dispersion matrix and trapping the particulates and fluids in the matrix.

Also disclosed herein are products incorporating the cleaning compounds as described. In general, similar cleaning products typically comprise at least one of a release agent, a dispersant, and a collector of particulates and fluids. However, as disclosed herein, the cleaning compound may be each of the release agent, the dispersant, and the collector simultaneously.

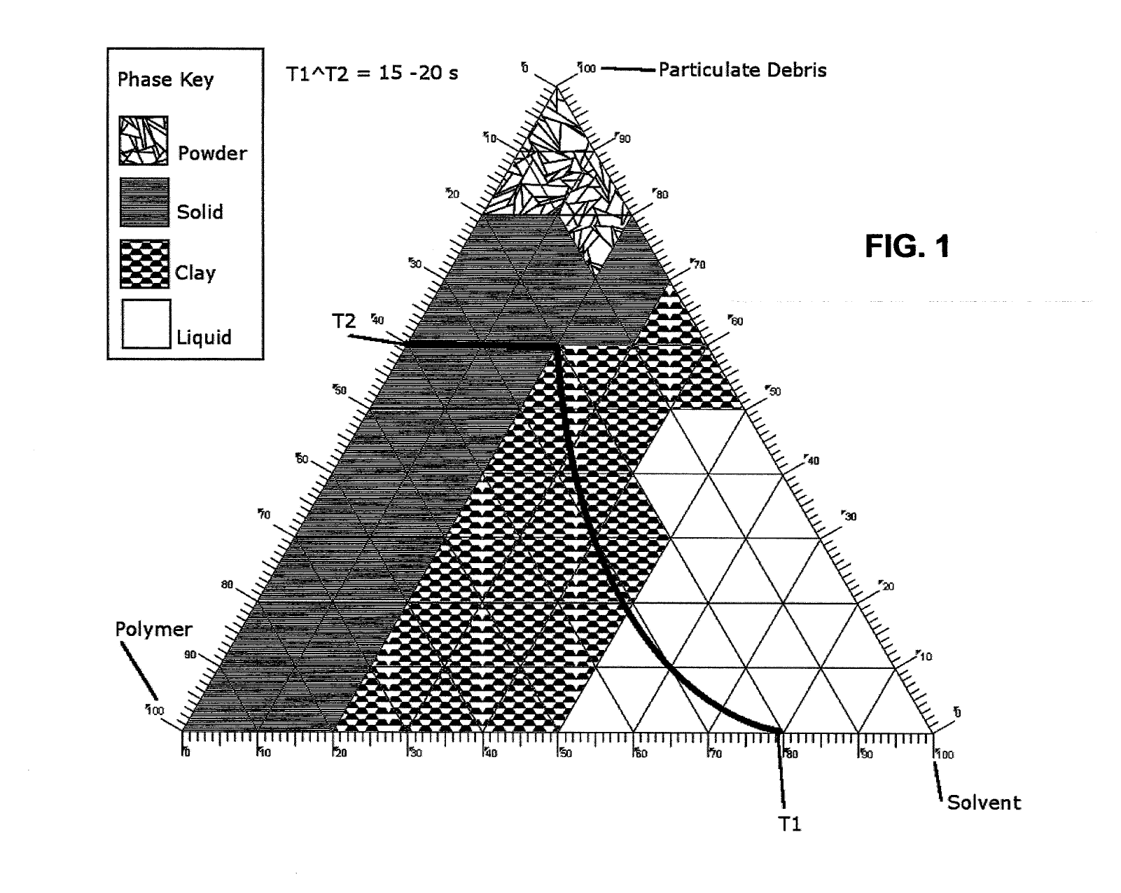

Referring now to FIG. 1, a graph is shown for a specific formulation of a cleaning compound according to an embodiment of the present disclosure, but illustrates the general range of several formulations. Specifically, FIG. 1 illustrates the physical phase change from a liquid T1 to a solid T2 plotted across time as the solvent evaporates and the compound incorporates into and then traps foreign particulates in its mass. The left side of the graph shows solid material which over time changes into clay and then liquid. The graph is an example of one formulation, and several other graphs could be plotted for various compound formulations. In some embodiments, the time between T1 and T2 (T1̂T2), or the phase transition time, is from about 1 to about 300 seconds, or from about 1 to about 1 to about 120 seconds, or from about 1 to about 60 seconds, or from about 1 to about 30 seconds, or from about 15 to about 20 seconds.

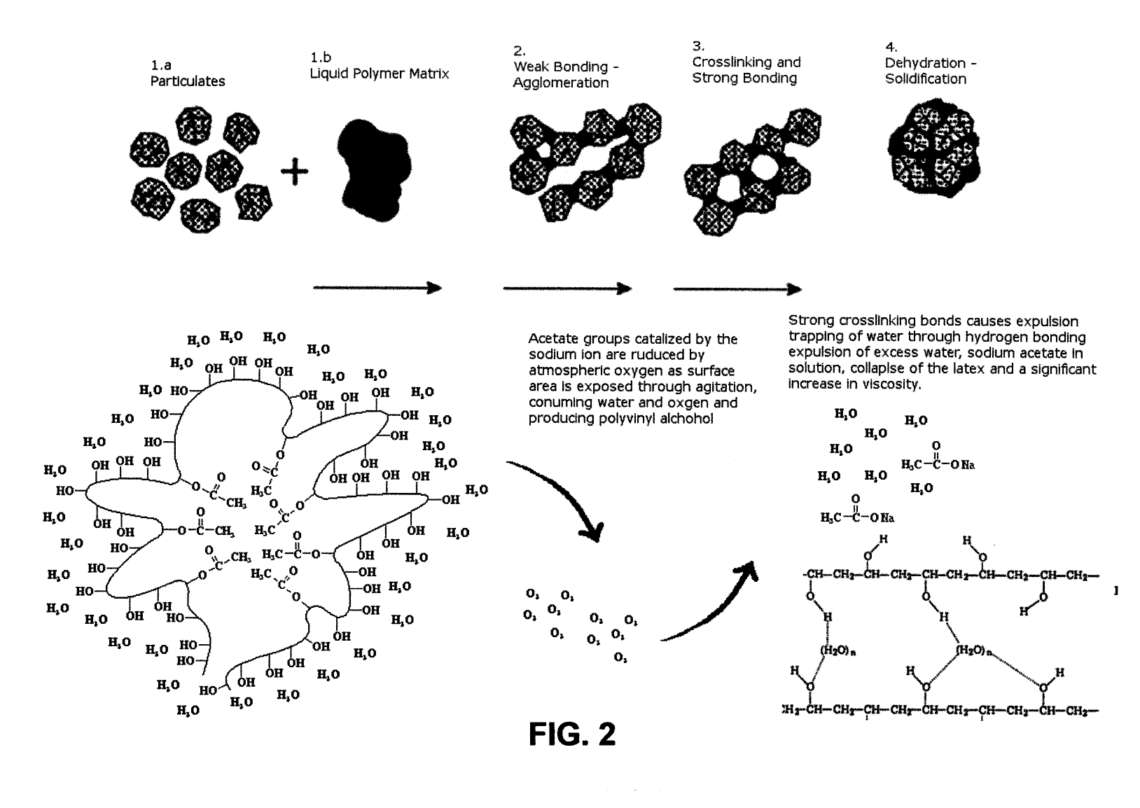

Referring now to FIG. 2, a graph illustrating the cleaning mechanism according to one embodiment of the present disclosure. For example, in particular embodiments, particulates encounter a liquid polymer matrix (i.e., a dispersion matrix formed by the activation of the cleaning compounds described herein) to form a weak bonding agglomeration. As the activation of the cleaning compound proceeds, crosslinking occurs and a stronger bonding agglomeration is formed. Eventually, the compound changes phase to a solid, soft solid, or viscous gel through a solidification-dehydration process. In more specific embodiments, acetate groups of the polymerizing agent are catalyzed and the sodium ion are reduced by atmospheric oxygen as the surface area of the cleaning compound is exposed through agitation, which results in the consumption of water and oxygen and produces polyvinyl alcohol. Strong crosslinking bonds are formed, causing the expulsion of excess water, sodium acetate in solution. This process also causes the collapse of the cleaning compound and a significant increase in viscosity, thus completing the transition to a solid, soft solid, or viscous gel.

The following examples are provided to illustrate the compounds, parts, components, processes, and properties of the present disclosure. The examples are merely illustrative and are not intended to limit the disclosure to the materials or conditions set forth therein.

### EXAMPLES

Three cleaning compounds, labeled as Formulas 1-4, are provided as exemplary embodiments according to the present disclosure. Table A below lists the makeup by component percentage of these four compounds.

TABLE A

| | Formula 1 | Formula 2 | Formula 3 | Formula 4 |
|---|---|---|---|---|
| Component | (wt %) | (wt %) | (wt %) | (wt %) |
| A | 28 | 26 | 56 | 80-86 |
| B | 20 | 23 | 19 | 5 |
| C | 1 | 0 | 2 | 2 |
| D | 1 | 0 | 2 | |
| E | 22 | 20 | 4.5 | 0.3-5.5 |
| F | 22 | 26 | 7 | |
| G | 5 | 2.5 | 0.5 | 5 |
| H | 1 | 1.5 | 3 | 1 |
| I | | | | 2 |

With reference to TABLE A, the components listed refer to the following components of the cleaning compounds disclosed herein. For example, Component A refers to the polymerizing agent. Component B refers to the antimicrobial agent. Component C refers to the adhesion controller. Component D refers to the reaction inhibitor. Component E refers to the viscosity controller. Component F refers to the drying agent. Component G refers to the polymerization catalyst. Component H refers to the surfactant. Component I refers to the plasticizer.

Formula 1

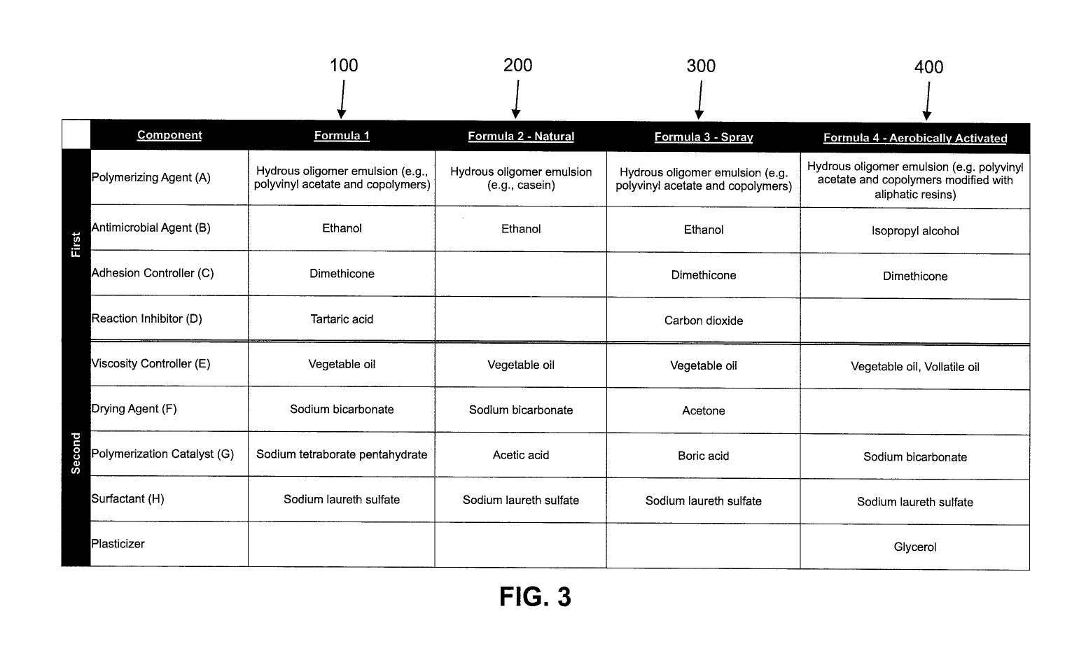

With reference to FIG. 3, Formula 1 (100) consists of a first part and a second part. The first part comprises: polyvinyl acetate and polyvinyl acetate copolymers as the polymerizing agent; ethanol as the antimicrobial and preservative; dimethicone as an adhesion controller, stabilizer, and to assist in the removal of solids from the surface; and tartaric acid as a tackifier, stabilizer, reaction retardant and secondary catalyst. The second part comprises: vegetable oil as a binder, viscosity controller, and nonionic solvent; sodium bicarbonate as a drying agent, pH adjustor, and an abrasive; sodium tetraborate pentahydrate as a polymerization catalyst; and sodium laureth sulfate as a surfactant.

With reference to FIG. 3, Formula 1 (100) may have the percentages of each component as listed in TABLE A.

Formula 2—Natural

With reference to FIG. 3, Formula 2 (200) consists of a first part and a second part. The first part comprises: casein as the polymerizing agent; and ethanol as the antimicrobial agent and preservative. The second part comprises: vegetable oil as the viscosity controller, binder, and nonionic solvent; sodium bicarbonate as the drying agent, pH adjustor, and abrasive; acetic acid as the polymerization catalyst; and sodium laureth sulfate as the surfactant.

With reference to FIG. 3, Formula 2 (200) may have the percentages of each component as listed in TABLE A.

Formula 3—Spray

With reference to FIG. 3, Formula 3 (300) consists of a first part and a second part. The first part comprises: polyvinyl acetate polymers and copolymers as the polymerizing agent; ethanol as the antimicrobial agent, solvent and preservative; dimethicone as the viscosity controller, stabilizer treatment to controller the adhesion of the compound, and to assist in the removal of solids from a surface; and carbon dioxide as the reaction inhibitor, stabilizer, blowing agent, and propellant. The second part comprises: vegetable oil as the viscosity controller, binder, and nonionic solvent; acetone as the drying agent and solvent; boric acid as the polymerization catalyst; and sodium laureth sulfate as the surfactant.

With reference to FIG. 3 Formula 3 (300) may have the percentages of each component as listed in TABLE A.

Formula 4—Aerobically Activated

With reference to FIG. 3, Formula 4 (400) consists of 8 components in two parts, the components including: a polymerizing agent, an antimicrobial agent, an adhesion controller, two viscosity controllers, a polymerization catalyst, a surfactant, and a plasticizer. The compound comprises: polyvinyl acetate polymers and copolymers modified with alphatic resins as a hydrous oligomer emulsion as the polymerizing agent; isopropyl alcohol (U.S.P.) as an antimicrobial, solvent and preservative; sodium bicarbonate as a polymerization catalyst, amphoteric buffer agent, and saponifier; liquid vegetable oil (e.g., olea europaea) as a binder, viscosity controller, nonionic solvent, and humectant; sodium laureth sulfate as a surfactant; dimethicone as a viscosity controller, stabilizer, and treatment to control adhesion of the compound and assist in the removal of solids from surfaces; glycerol as a plasticizer; and a volatile oil, such as lemon (limonene) or cymbopogon (lemongrass), as a solvent and viscosity controller.

With reference to FIG. 3, Formula 4 (400) may have the percentages of each component as listed in Table A or described herein. For example, in some embodiments a cleaning compound according to Formula 4 may have the following amounts of each component: from about 80.8 wt % to about 86 wt % of a polyvinyl acetate copolymer emulsion; about 5 wt % of isopropyl alcohol; about 5 wt % of sodium bicarbonate; from about 0.2 wt % to about 5 wt % of vegetable oil; about 1 wt % of sodium laureth sulfate; about 2 wt % of dimethicone; about 2 wt % of glycerol; and from about 0.1 wt % to about 0.5 wt % of a volatile oil.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A polymer compound for cleaning, the compound comprising:
a first part; and
a second part;
wherein the compound activates to form a dispersion matrix that traps at least one of a particulate and fluid from a surface.

2. The compound of claim 1, wherein the compound is activated at least when the first part and the second part are combined.

3. The compound of claim 1, wherein at least one part is suspended in at least one other part as microbeads.

4. The compound of claim 3, wherein the compound is activated at least when the microbeads are broken-down due to agitation.

5. The compound of claim 1, wherein at least one part is hydrophilic and at least one other part is lipophilic.

6. The compound of claim 1, wherein the compound becomes more viscous after the compound is activated.

7. The compound of claim 1, wherein the compound changes phase from a liquid to at least one of a solid, soft solid, and viscous gel after the compound is activated.

8. The compound of claim 1, wherein the compound becomes less adhesive after the compound is activated.

9. The compound of claim 1, wherein the at least one part comprises a reaction inhibitor, and the compound is activated at least when the reaction inhibitor evaporates.

10. The compound of claim 9, wherein the reaction inhibitor is also a blowing agent that causes the compound to expand when the compound is activated.

11. A polymer compound for cleaning a surface, the compound comprising:
a polymerizing agent;
an antimicrobial agent;
a viscosity controller;
a polymerization catalyst; and
a surfactant.

12. The compound of claim 11, wherein the polymerizing agent is a hydrous oligomer emulsion.

13. The compound of claim 11, wherein the antimicrobial agent is also at least one of a preservative and a solvent.

14. The compound of claim 11, wherein the viscosity controller is also at least one of a binder and a nonionic solvent.

15. The compound of claim 11, wherein the compound further comprises at least one of:
an adhesion controller;
a reaction inhibitor;
a drying agent;
a buffer agent;
a crosslinking agent.

16. The compound of claim 15, wherein the drying agent is also at least one of a pH adjustor, an abrasive, and a solvent.

17. The compound of claim 15, wherein the adhesion controller is also a viscosity controller.

18. The compound of claim 15, wherein the reaction inhibitor is also at least one of a blowing agent, a propellant, and a stabilizer.

19. A product containing a cleaning compound as described in claim 1, wherein the product comprises at least one of a release agent, a dispersant, and a collector of particulates and fluids.

20. The product of claim 40, wherein the compound is the release agent, dispersant, and the collector of particulates and fluids.
